(19) United States
(12) Patent Application Publication
(10) Pub. No.: US 2004/0137840 A1
(43) Pub. Date: Jul. 15, 2004

(54) Bi-directional transponder apparatus and method of operation

(76) Inventors: Michael de La Chapelle, Bellevue, WA (US); William H. Jones, Seattle, WA (US)

Correspondence Address: HARNESS, DICKEY & PIERCE, P.L.C., P.O. BOX 828, BLOOMFIELD HILLS, MI, 48303, US

(21) Appl. No.: 10/342,762

(22) Filed: Jan. 15, 2003

(51) Int. Cl. H04B 7/185; H04Q 7/20

(52) U.S. Cl. 455/12.1; 455/427

(57) ABSTRACT

A bi-directional radio frequency transponder apparatus and method of operation therefor. The single, bi-directional transponder has its bandwidth segmented into two distinct, non-overlapping frequency portions, one for handling forward link signals from a base station to a mobile platform and the other for handling return link signals from the mobile platform to the base station. The output of the transponder is reduced by at least about 1 dB below saturation, and more preferably by about 1 dB-3 dB below saturation. This prevents suppression of the relative small return link signals in the presence of the much larger forward link signals. The overall cost of the transponder system is reduced by half over that of a conventional dual transponder system without significantly degrading forward link or return link capacity.

### FIELD OF THE INVENTION

The present invention relates to radio frequency transponders, and more particularly to a single, bi-directional radio frequency transponder capable of facilitating simultaneous forward and return RF transmission links between a communications station and a mobile platform.

### BACKGROUND OF THE INVENTION

Presently there is growing interest in providing communication systems which are capable of handling RF communications between a ground based RF communications station and one or more mobile platforms, such as commercial aircraft, operating within a predefined coverage region. The base station is used to transmit information via RF signals to a space-based RF transponder, which typically comprises a satellite-based RF transponder. The satellite-based RF transponder transponds the information to the mobile platform which carries an RF transceiver. The operation of transmitting information from the base station to the mobile platform can be viewed as a “forward link” transmission. The satellite-based transponder is also used to transmit RF signals from the mobile platform to the base station. These transmissions can be viewed as “return link” transmissions. One such system is disclosed in U.S. patent application Ser. No. 09/989,742, filed Nov. 20, 2001, the disclosure of which is hereby incorporated by reference.

With such communication systems as described above, it is common for the space-based transponder system to include one transponder dedicated to forming the forward link, and a separate transponder dedicated to forming the return link. Obviously, the use of two transponders to facilitate bi-directional communication between the base station and the mobile platform introduces increased costs over what would be borne if only a single transponder could be used to facilitate both the forward link and the return links as needed. Until the present time, however, the forward link transponder of a two transponder system has been operated such that its effective isotropic radiated power (i.e., “EIRP”, but henceforth called simply “power”) is at saturation, which is the maximum output power condition for a typical transponder. The reason for saturating the forward link transponder is that the information carrying capacity (henceforth referred to as “capacity”) of the forward link is proportional to the transponder output power, and it is typically the objective of any communication system to maximize capacity. In technical terms, the forward link is considered to be transponder “power limited”. Operating the forward link transponder at saturation, however, typically gives rise to the problem of small-signal suppression of the return link signals transmitted from the mobile platform to the base station, when both signals are input to the same transponder. The reason why return link signals transmitted towards the satellite from the mobile platforms are much lower amplitude than forward link signals transmitted to the satellite from a ground station is that mobile antennas are typically much smaller and use much lower power amplifiers compared to typical large and powerful ground station antennas. Thus, ground station antennas used for transmitting towards the satellite can typically saturate the forward link transponder, whereas small, low-power mobile antennas typically cannot. The return link capacity is not limited by the power of the transponder, but instead by the transmit power of the mobile antenna. In this situation, the return link capacity is limited by the channel bandwidth, and the return link is considered to be “frequency limited”. As previously mentioned, operating a forward transponder at saturation is desirable for maximizing capacity, but such operation also causes suppression of the return link signals by a well known non-linear effect called “small signal suppression”, which occurs in all saturated devices. To avoid suppression of the return link signal, the transponder must be operated in its linear range, which requires the transponder to be “backed off” from power saturation. Backing off from transponder saturation causes a loss of transmit power and a corresponding loss of forward link capacity. Thus, until the present time, use of separate transponders for the forward and return links has been viewed as the best approach for two-way satellite communication between a mobile terminal and a ground station. The drawback of the present approach is that a minimum of two transponders are required to establish two-way communication in a transponder coverage region, and satellite transponders are a very expensive resource. When establishing new communication service in a region, it is highly desirable to minimize start-up costs by using a single transponder rather than two.

Therefore, it would be especially desirable to provide a communication system by which a single, bi-directional, RF transponder could be used to handle both forward link and return link transmissions without introducing an unacceptable loss of capacity on either link. More succinctly, there is an economic advantage to establishing communication services in a region with a single transponder, without reducing the efficiency (cost per bit) that is achieved when operating with two transponders. In effect, the use of a single, bi-directional, space-based transponder would allow the operation of a communications system in those geographic regions where RF connectivity between a base station and a mobile platform is desired, but where the level of use of such a system may not necessarily warrant the initial expenditure of a dual transponder system.

### SUMMARY OF THE INVENTION

The present invention is directed to a bi-directional communication system employing a single, bi-directional transponder. The single, bi-directional transponder has its overall bandwidth segmented into distinct, non-overlapping first and second portions frequency bands. One portion is dedicated to facilitating forward link (FL) transmissions while the other portion is dedicated to facilitating return link (RL) transmissions. The power output level of the transponder is further set to a predetermined power level that is below saturation of the power output of the transponder. In one preferred form, the predetermined power level is set 3 dB below saturation.

Segmenting the transponder bandwidth into distinct first and second, non-overlapping portions, and reducing the output of the transponder to the predetermined power level allows forward link signals to be transmitted without causing significant small signal suppression of the return link signals. While the reduction in power output of the transponder does produce a reduction in the forward link data rate (in proportion to the transponder output “back-off”), the forward link transponder power reduction enables the return link to share the transponder with little or no performance degradation.

In a preferred form the RF signals transmitted over the forward link are spread via a suitable spreading scheme to maintain a total power spectral density (PSD) of the transmitted signals below a predefined PSD limit set by governmental regulatory agencies concerned with management of the radio spectrum, or informally negotiated between satellite owners and operators. Signals transmitted by the mobile platform over the return link are also preferably spread by a suitable spreading scheme such as non-overlapped frequency division multiplexing (FDM), overlapped FDM, time division multiple access (TDMA) or code division multiple access (CDMA).

The ability to provide a transponder system which requires only a single, bi-directional transponder to facilitate bi-directional communications between the ground-based station and the mobile platform represents a significant cost reduction in the overall communications system for coverage regions where demand is light. This significant cost reduction enables a communications system to be implemented in geographic regions where the limited degree of revenue that could be generated from usage of the transponder system would not be enough to offset the initial cost of a dual-transponder system.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a prior art, simplified schematic representation of a prior art, dual transponder system for facilitating communications between a ground based communication station and a mobile platform such as an aircraft;

FIG. 2 is a simplified diagram of a communications system in accordance with the present invention in which a single, bi-directional transponder is utilized for handling forward and return link communications between the ground based communications station and the mobile platform;

FIG. 3 is a simplified diagram of the segmenting of the overall bandwidth of the single, bi-directional transponder of the present invention;

FIG. 4 is an exemplary graph of the transponder effective isotropic radiated power (EIRP) vs. ground station transmit EIRP, illustrating an operating point that causes a 3 dB reduction from saturation of the output power level (output back-off) of the single, bi-directional transponder of the present invention;

FIG. 5 is an exemplary frequency plan (the units are MHz) for several different satellite-based transponders presently orbiting the earth; and

FIG. 6 is a chart illustrating the performance difference between a prior art, dual transponder system and the single, bi-directional transponder, assuming that the forward link signal is backed-off by 3 dB for bi-directional operation in accordance with the present invention and that the forward link transponder is operated at saturation for the dual transponder (prior art) configuration.

### DETAILED DESCRIPTION OF THE PREFERRED EMBODIMENTS

The following description of the preferred embodiment(s) is merely exemplary in nature and is in no way intended to limit the invention, its application, or uses.

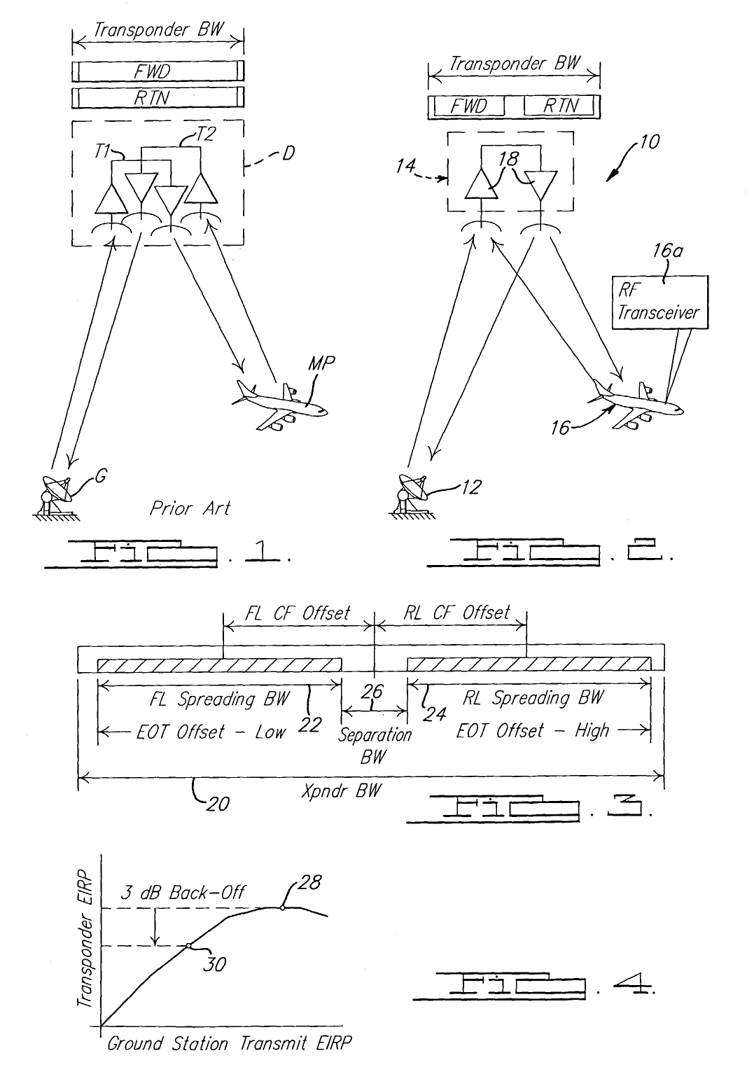

Referring to FIG. 1, there is shown a prior art, simplified diagram of a ground-based communications system “G” in communication with a mobile platform “MP” via a conventional, dual transponder system “D”. A dedicated forward link transponder T1 is used to facilitate a forward link (FL) between the ground station and the mobile platform, while a separate, dedicated transponder T2 is used to facilitate a separate return link (RL). The use of two dedicated transponders effectively doubles the cost of the transponder system D over what would be incurred with the implementation of a single, bi-directional transponder.

Referring now to FIG. 2, a communications system 10 in accordance with a preferred embodiment of the present invention is illustrated in highly simplified form. The system 10 includes a ground-based, radio frequency (RF) communications station 12, a single, bi-directional transponder system 14 and a mobile platform 16 having an on-board RF transreceiver system 16a. The communications station 12 transmits forward link signals to the transponder system 14 which are relayed to the RF transreceiver 16a of the mobile platform 16. RF signals transmitted by the RF transreceiver 16a from the mobile platform 16 form return links signals that are transponded by the transponder system 14 to the communications station 12. It will be appreciated that while the mobile platform 16 is depicted as an aircraft, that the mobile platform could just as readily form a bus, ship, train or other moving vehicle. Similarly, while the communications station 12 is illustrated as a ground-based facility, this component could just as readily be deployed on a mobile platform as well. The bi-directional transponder system 14 typically is provided on a satellite operating in geosynchronous orbit over a predefined coverage region to provide continuous RF connectivity between the communications station 12 and the mobile platform 16 as the mobile platform travels within the predefined coverage region.

With further reference to FIG. 2, the transponder system 14 includes a single, bi-directional transponder 18. The overall bandwidth of transponder 18 is segmented into distinct, non-overlapping first and second segments. Put differently, the bandwidth of transponder 18 is partitioned into two, non-overlapping portions. With reference to FIG. 3, a graphic representation of the segmenting of the transponder bandwidth is provided. The overall transponder bandwidth is represented by line 20. The bandwidth allocated to forward link (FL) transmissions is represented by line 22. The bandwidth allocated for return link (RL) transmissions is indicated by line 24. It will be noted that a small amount of optional bandwidth termed the “separation” bandwidth is indicated by line 26. This separation bandwidth 26 further insures that the high amplitude forward link signal 22 does not interfere with the relatively low amplitude signal 24. Note that the portion of the transponder bandwidth allocated to the return link 24 may be further subdivided into individual frequency division multiple access (FDMA) channels, but a preferred embodiment has a return link single channel that shared by multiple aircraft using Code Division Multiple Access (CDMA). It will also be appreciated that the center frequency for the forward and return links are offset from the center of the overall transponder bandwidth, as indicated by the designations “FL CF Offsets” and “RL CF Offset” in FIG. 3. Furthermore, the forward link bandwidth is offset slightly from the low edge of the overall transponder frequency bandwidth, as indicated by the designation “EOT Offset—Low”, while the return link bandwidth is offset slightly from the high edge of the overall transponder bandwidth, as indicated by the designation “EOT Offset—High”. The use of these two offsets from the low and high edges of the transponder bandwidth are desirable because transponder performance degrades at the upper and lower edges of the bandwidth.

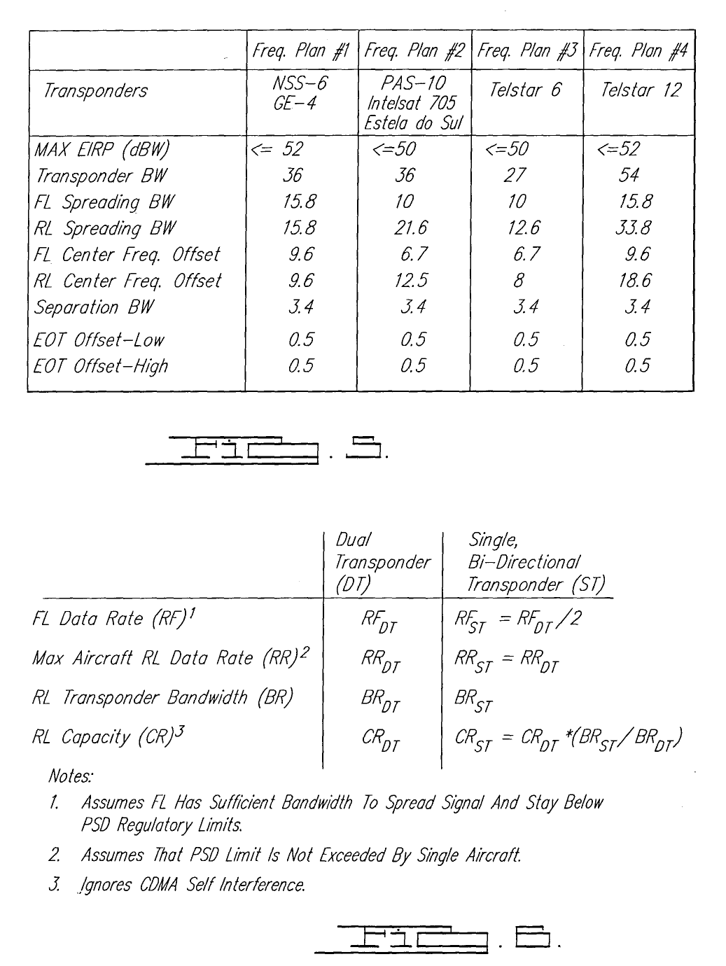

An important factor in utilizing the single transponder 18 to accommodate both forward link and return link transmissions without suffering small signal suppression of the return link signals is that the transponder output is reduced (i.e., backed off), by preferably 1 dB to 4 dB from saturation. This is illustrated in FIG. 4. Point 28 represents the operating point for a conventional, dedicated, forward link transponder typically utilized in a system incorporating separate transponders for forward link and return link transmissions. The operating point for the transponder 18 is reduced below saturation by about 3 dB, as indicated by point 30. Reducing the transponder 18 output to about 3 dB below saturation eliminates the risk of suffering significant suppression of the return link transmission from the aircraft 16 to the ground based communications station 12 when this signal is combined on the same transponder 18 with the stronger forward link signal from (the communications station 12 to the mobile platform 16. The forward and return links further are operated on separate frequencies to implement the bi-directional operation of the transponder 18. In a preferred embodiment, signal spreading is incorporated with both the forward link and return link signals. Any suitable means of signal spreading or return link multiple access may be employed with the present invention. Examples of suitable multiple access methods include non-overlapped frequency division multiplexing (FDM), overlapped FDM, time division multiple access (TDMA), code division multiple access (CDMA), or hybrids thereof. As mentioned previously, the capacity of the return link portion of the bi-directional transponder 18 is proportional to the return link bandwidth. Thus, by partitioning the transponder 18 into the forward and return link portions, some capacity is sacrificed relative to what would be achieved from a transponder dedicated to return link operation (the prior art method). This trade-off is illustrated in FIG. 6. Bi-directional operation of the present invention has the greatest advantage over dual transponder operation when the transponder bandwidth is wide and the required forward link bandwidth is small. It will also be appreciated that the peak return link data transmission rate from the mobile platform 16 is not affected by bi-directional operation of the transponder 18, given that the forward link signal is sufficiently backed-off to prevent small signal suppression of the return link.

With brief reference to FIG. 5, an exemplary transponder frequency plan for bi-directional operation of the transponder 18 is illustrated. The forward link spreading bandwidth is determined by several considerations. First, the bandwidth must be spread sufficiently wide to keep the peak effective isotropic radiated power (EIRP) spectral density below the coordination limits for the satellite/transponder being used. Put differently, the peak EIRP spectral density needs to be spread to avoid interference with satellite/transponder systems orbiting in the vicinity of the transponder 18. For example, the peak EIRP for satellite AMC-4 (formerly GE-4) is 51 dBW. The coordination limit for the satellite is 13 dBW/4 KHz. Given a 3 dB transponder output back-off, the minimum required forward link spreading bandwidth is: 51 dBW−3 dB−13 dBW/4 KHz=35 dB−4 KHz , which equals 12.6 MHz.

A second consideration is to only spread the forward link signal by that amount that is necessary to stay below the peak EIRP spectral density that is imposed by government regulatory requirements and any preexisting satellite coordination agreements. Spreading the forward link signal more than necessary reduces the bandwidth, and hence capacity, available for the return link transmissions.

Referring briefly now to FIG. 6, it can be seen that operation with a single bi-directional transponder is approximately as efficient (from a cost standpoint) in operation as a dual transponder system. For bi-directional operation, the forward link data rate is approximately halved when the transponder output back-off is 3 dB (a factor of 2). The table of FIG. 6 assumes a 3 dB back-off. The return link capacity, which is proportional to the available return link bandwidth, is reduced relative to dual transponder capacity by the ratio of the bi-directional return link bandwidth divided by the total transponder bandwidth. For typical Ku-band transponders having bandwidths of 27 MHz, 36 MHz and 72 MHz, the return link capacity reduction is less than 50% using the numbers from FIG. 6 for the exemplary commercial satellites listed in FIG. 5. Therefore, the cost-per-bit for data transmitted by a single, bi-directional transponder is less than that of a dual transponder system because the cost is halved but both the forward link and return link capacity are each reduced by less than half.

The present invention thus allows implementation of a communications system between a base station and a mobile platform via a single, bi-directional, transponder. This significantly reduces the initial costs of implementing such a system because of the need for only a single, bi-directional transponder rather than the dual transponder system previously utilized. By segmenting the bandwidth of a single, bi-directional transponder into non-overlapping bandwidth segments, and by reducing the output of the single, bi-directional transponder by a predetermined amount, the single transponder is able to accommodate both forward link and return link transmissions without negatively impacting the relatively small, return link signals from the mobile platform. The requirement of only a single, bi-directional transponder thus enables implementation of a ground-based-to-mobile-platform communication system in those geographic regions where the level of anticipated use of the system may not be sufficient to justify the implementation of a dual transponder system, but would be sufficient to justify by a single, bi-directional transponder system because of the significantly reduced cost of such a system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for providing a bi-directional, radio frequency (RF) communications link between a mobile platform and a communications station using a single, space-based transponder, comprising:
segmenting a total bandwidth of said transponder into first and second portions;
setting a power output of said transponder at a predetermined power output level that is below saturation of said power output of said transponder;
using said transponder to transmit RF signals received from said communications station to said mobile platform at said predetermined power output level over said first bandwidth portion of said transponder; and
using said transponder to transmit RF signals received from said mobile platform to said communications station at said predetermined power output level over said second bandwidth portion of said transponder.

2. The method of claim 1, wherein setting said power output of said transponder comprises setting said power output to a level of 1-4 dB below saturation of said power output of said transponder.

3. The method of claim 1, further comprising spreading said RF signals transmitted by said communications station to said transponder.

4. The method of claim 1, further comprising spreading said RF signals transmitted by said mobile platform to said transponder.

5. The method of claim 1, further comprising using a plurality of mobile platforms to communicate bi-directionally and simultaneously with said communication station using said spaced-based transponder.

6. The method of claim 5, further comprising using at least one of code division multiple access (CDMA), and frequency division multiple access (FDMA), and time division multiple access (TDMA) to spread RF signals transmitted from said mobile platforms.

7. The method of claim 6, wherein a combination of at least two of CDMA, FDMA and TDMA signal spreading techniques are employed to spread said RF signals.

8. The method of claim 5 wherein using said mobile platforms comprises using an aircraft, and wherein using said communication station comprises using a fixed ground station.

9. A method for forming a bi-directional, radio frequency (RF) communications link between a mobile platform and a base station using a single, satellite-based transponder, comprising:
segmenting a total bandwidth of said transponder into first and second portions;
setting a power output of said transponder at a power output level that is at least about 1 dB below saturation of said power output of said transponder;
using said first bandwidth portion to form a forward transmission link over which RF signals are transmitted from said base station to said mobile platform; and
using said second bandwidth portion to form a return transmission link over which RF signals are transmitted from said mobile platform to said base station.

10. The method of claim 9, further comprising spreading said RF signals transmitted from said base station to said transponder.

11. The method of claim 9, further comprising spreading said RF signals transmitted from said mobile platform to said transponder.

12. The method of claim 11, wherein said spreading comprises one of;
non-overlapped frequency division multiplexing (FDM);
overlapped FDM;
time division multiple access (TDMA); and
code division multiple access (CDMA).

13. The method of claim 11, wherein said RF signals are spread to a sufficient degree to meet a regulatory requirement for total power spectral density (PSD) of signals transmitted by said base station.

14. A method for operating a single radio frequency (RF) transponder to facilitate a bi-directional communications link between a first RF communications station and a second RF communications station, comprising:
segmenting an overall bandwidth of said transponder into first and second portions;
setting a power output of said transponder at a predetermined power output level that is below saturation of said power output of said transponder;
using said first bandwidth portion to form a forward communications link for RF signals received by said transponder from said first communications station and transmitted by said transponder to said second communications station; and
using said second bandwidth portion to form a return communications link for RF signals received from said second communications station by said transponder and transmitted by said transponder to said first communications station.

15. The method of claim 14, wherein setting said power output comprises setting said power output at a power level that is at least about 1 dB below saturation of said power output of said transponder.

16. The method of claim 15, wherein setting said power 9 output comprises setting said power output at a level of approximately 1-3 dB below saturation of said power output of said transponder.

17. The method of claim 14, further comprising spreading said RF signals transmitted by said first communication station to maintain a total power spectral density (PSD) of said RF signals below a regulatory PSD limit.

18. The method of claim 14, further comprising spreading said RF signals transmitted by said second communications station.

19. The method of claim 18, wherein said spreading comprises one of:
non-overlapped frequency division multiplexing (FDM); and
overlapped FDM; and
time division multiple access (TDMA); and
code division multiple access (CDMA).

20. The method of claim 19, wherein said spreading comprises a combination of at least two of said non-overlapped FDM, and said overlapped FDM, and said TDMA and said CDMA.

21. A space based, radio frequency (RF) transponder for facilitating a bi-directional communications link between a communications station and a mobile platform operating within a predefined geographic coverage region in which said communications station is located, said transponder comprising:
an overall bandwidth partitioned into first and second portions, said first portion forming a forward link transmission path from said communications station to said mobile platform, and said second portion forming a return link transmission path from said mobile platform to said communications station; and
a power output of said transponder being set at a predetermined power output level that is below saturation of said power output of said transponder.

22. The transponder of claim 21, wherein said power output level comprises a power level that is between approximately 1 dB-4 dB below saturation of said power output.

23. The transponder of claim 21, wherein said power output level comprises a power level that is at least about 1 dB below saturation of said power output.

24. A communications system, comprising:
a radio frequency (RF) communications station located within a predefined geographic coverage region;
a mobile platform carrying a RF transceiver, said mobile platform operating within said geographic coverage region;
a space-based RF transponder orbiting the earth above said predefined geographic coverage region;
said space-based transponder including:
an overall bandwidth that is segmented into first and second, non-overlapping portions; and
a power output that is set at a predetermined level below saturation;
said first bandwidth portion being used to form a forward transmission link between said RF communications station and said mobile platform; and
said second bandwidth portion being used to form a return transmission link between said mobile platform and said RF communications station.

25. The system of claim 24, wherein said mobile platform comprises an aircraft.

26. The system of claim 24, wherein said RF communications station comprises a ground based RF communications station.

27. The system of claim 24, wherein said RF communications station uses a spreading scheme to spread RF signals transmitted therefrom.

28. The system of claim 24, wherein said RF transceiver on said mobile platform uses a spreading scheme to spread RF signals transmitted therefrom.

29. The system of claim 28, wherein said spreading scheme comprises one of:
non-overlapped frequency division multiplexing (FDM); and
overlapped FDM; and
time division multiple access (TDMA); and
code division multiple access (CDMA).

30. The system of claim 24, wherein said predetermined level of said power output of said transponder comprises a power level set at least approximately 1 dB below saturation of said power output.
